(19) United States
(12) Patent Application Publication
(10) Pub. No.: US 2017/0231426 A1
(43) Pub. Date: Aug. 17, 2017

(54) COOKING STOVE

(71) Applicant: Standard Brands (UK) Limited, Surrey (GB)

(72) Inventor: Eric Dennis BARFORD, Surrey (UK)

(21) Appl. No.: 15/505,770

(22) PCT Filed: Jul. 23, 2015
(86) PCT No.: PCT/GB2015/052126

§ 371 Date: Feb. 22, 2017

(30) Foreign Application Priority Data
Aug. 22, 2014 (GB) 1414979.3
Jan. 29, 2015 (GB) 1501449.1

(51) Int. Cl. A47J 37/07; F24C 1/16; F23D 3/02; F24B 1/20

(52) U.S. Cl. CPC A47J 37/0754; F24B 1/202; F24C 1/16; F23D 3/02

(57) ABSTRACT

A cooking stove (2) comprising a fan (14) configured to force air into a combustion chamber (8) through air inlets (10) in the walls (4) of the combustion chamber (8). The air inlets (10) are positioned at least 30 mm from the base (6) of the combustion chamber (8) and direct the forced air to the headspace above the fuel (20). Clean combustion of high energy fuels can be achieved by the cooking stove (2).

### FIELD OF INVENTION

This technology relates to cooking stoves, in particular, to lightweight, efficient, and portable outdoor cooking stoves for use primarily by those undertaking general camping or other outdoor leisure pursuits, or by larger groups of people for entertaining or humanitarian purposes. The cooking stoves are designed to make efficient use of solid fuel blocks and to minimise the soot deposited on the cooking vessel.

### BACKGROUND TO THE INVENTION

Outdoor enthusiasts and military personnel that carry their own equipment, often for extended periods of time, need their equipment to be lightweight and suitable for compact storage. Environments that do not offer a source of fuel, such as dried wood, are frequently encountered, requiring the prudent person also to carry their own fuel. Stoves that can be used with solid fuel blocks have been developed. In addition to their use by outdoor enthusiasts and military personnel, solid fuel blocks are well suited to humanitarian applications.

Solid fuel blocks that are on the market include hexamine blocks, trioxane blocks, solidified methyl decanoate blocks and gelled alcohol packs. These blocks prevent the need for extra containers (as with gas or liquid fuels) or regulation equipment (pressure regulators or valves) and reduce the risk of fuel spillage or other accidental release.

Methyl, ethyl, propyl, or butyl esters of a C6-C14 carboxylic acid, of which methyl decanoate is the most popular, are particularly advantageous as the fuel of solid fuel blocks. The C6-C14 esters have favourable flash points and boiling ranges for solid fuel blocks. The present invention concerns stoves designed to be used with these particular fuels, as well as with hexamine blocks.

Prior art stoves have generally not been designed specifically with burning solid fuel blocks in mind. Instead, most prior art stoves have been designed to utilise a number of fuels, including wood. The efficiency with which these stoves transfer heat from burning solid fuel blocks to a cooking vessel is not optimal.

When using a solid fuel block, the fuel block is placed in the combustion chamber of the stove and a cooking vessel is placed on top of the stove. The solid fuel is set alight and the flames heat the cooking vessel. A problem that is typically encountered with solid fuel blocks is that fuel blocks burn aggressively leading to tall flames. These tall flames often spill out of the top of the combustion chamber and spread out around the sides of the cooking vessel, resulting in lost heat energy. This lost heat energy must be accounted for by burning additional fuel blocks. In the long term this has environmental implications and in the short term means that a greater number of fuel blocks must be carried by the operator.

Further, if prior art stoves are used with solid fuel blocks, the fuel from the fuel blocks often does not completely combust, which leads to dangerous volatile organic compounds (white smoke) and/or soot (black smoke) being produced. The volatile organic compounds and/or soot are deposited on the cooking vessel, which makes it dirty to handle and store, and is unhygienic.

Combustion requires oxygen, and an oxygen supply is typically sustained by the rising flames of a combusting fuel convectively drawing fresh air through air inlets onto the fuel. One strategy that has been used to improve combustion of traditional fuels has been to artificially increase this air supply using forced air. Such an approach is described in U.S. Pat. No. 3,868,943 and WO 2006/103613. Unfortunately, however, the already aggressive burn of solid fuel blocks makes them incompatible with such a method.

There is, therefore, a need to provide a stove that can burn solid fuel blocks more efficiently to transfer more heat to the cooking vessel and reduce the soot deposited on the cooking vessel. The present invention aims to meet this need.

### SUMMARY OF THE INVENTION

According to a first aspect, the present invention provides a cooking stove comprising: a combustion chamber which is defined by walls and a base, the walls having one or more air inlets; and a fan configured to force air into the combustion chamber through the one or more air inlets; characterised in that the one or more air inlets in the walls of the combustion chamber are positioned at least 30 mm from the base.

According to a second aspect, the present invention provides a method of heating a cooking vessel using a cooking stove, the cooking stove comprising: a combustion chamber which is defined by walls and a base, the walls having one or more air inlets; and a fan configured to force air into the combustion chamber through the one or more air inlets; the method comprising the steps of: placing (a) a solid fuel block comprising methyl, ethyl, propyl or butyl esters of a C6 to C14 carboxylic acid or combinations thereof, or hexamine, or (b) a container comprising a wick and liquid fuel, on the base of the combustion chamber and setting the solid fuel block or container comprising a wick and liquid fuel alight; using the fan to force air through the one or more air inlets in the walls of the combustion chamber, wherein the one or more air inlets are all positioned above the solid fuel block or container comprising a wick and liquid fuel; and placing a cooking vessel onto the cooking stove.

According to a third aspect, the present invention provides a kit comprising a cooking stove and one or more solid fuel blocks and/or a container comprising a wick, wherein the one or more solid fuel blocks comprise methyl, ethyl, propyl or butyl esters of a C6 to C14 carboxylic acid or combinations thereof, or hexamine, and wherein the cooking stove comprises: a combustion chamber which is defined by walls and a base, the walls having one or more air inlets; and a fan configured to force air into the combustion chamber through the one or more air inlets; and characterised in that the one or more air inlets in the walls of the combustion chamber are configured to deliver air into the combustion chamber above the solid fuel block or container comprising a wick when the solid fuel block or container comprising a wick is positioned on the base of the combustion chamber.

As noted above, methyl, ethyl, propyl, and butyl esters of C6-C14 carboxylic acids, which shall be referred to as fatty acid esters (FAEs), are particularly advantageous as the fuel of solid fuel blocks. Of these methyl decanoate is currently the most popular. The present invention concerns stoves which are specifically designed to efficiently burn these FAE solid fuel blocks. The inventor has also discovered that the stove of the present invention is particularly suitable for burning hexamine blocks. Hexamine blocks have typically suffered from undergoing incomplete combustion and producing cyanuric combustion products, which have a high odour so can be detected by smell by the user. By using a stove according to the present invention to burn hexamine blocks, complete combustion can be achieved, minimising or even eliminating the presence of cyanuric combustion products deposited on the cooking vessel. Accordingly, the stoves of the present invention are also suitable for use with solid fuel blocks comprising hexamine.

In the past, cooking stoves that burn wood, charcoal briquettes, dried peat, coal, etc., have relied on having air inlets at fuel height to directly feed the burning fuel with air. A new way of burning adapted to FAE solid fuel blocks has been discovered by the inventor. If air is restricted from accessing the burning fuel at fuel height but is supplied to a headspace above the burning fuel, the main combustion occurs in this headspace above fuel height. The inventor has found that this leads to more efficient combustion than burning only the fuel block itself. This has led to the stove of the present invention, which has been designed to control the air flow in order to most efficiently combust FAE solid fuel blocks, resulting in more efficient transfer of energy from the fuel to a cooking vessel placed on the stove, and a reduction in the soot and unburned volatile organic compounds that are present in the exhaust fumes that can be deposited on the cooking vessel. As noted above, similar effects are shown with solid fuel blocks comprising hexamine.

Solid fuel blocks are often 20 mm high. As the stove of the first aspect of the present invention has air inlets at least 30 mm above the base, the air inlets would be above the block when placed on the base. In the second and third aspects of the invention, the air inlets are also positioned above the FAE or hexamine solid fuel block. This is a key difference from prior art forced air stoves where the air inlets are close to, and at least within 30 mm of, the base, and are designed to be at the level of the fuel. Accordingly, the stove of the present invention operates by forced air being supplied by a fan to the headspace above the burning solid fuel block. It is therefore vaporised fuel from the fuel block that benefits from the supply of air, and the vaporised fuel is therefore fully combusted without aggravating the aggressiveness of the burn of the solid fuel block itself. Surprisingly, even though air is not being supplied directly to the solid fuel block, the ultimate source of the fuel, the flame does not extinguish. The fuel block itself does still undergo combustion, albeit at a rate limited by the amount of oxygen that reaches the fuel block, and vaporises enough FAE or hexamine fuel to sustain the main combustion in the headspace. It is thought that the heat of the flame in the headspace feeds back to the fuel block and drives combustion and vaporisation of the fuel. The same principles apply for a container comprising a wick and a liquid fuel.

The invention operates by maximising the combustion of vaporised fuel without causing the rate of vaporisation from the solid fuel block to increase to an unmanageable level. Ordinarily, the heat of combustion would vaporise fuel from the fuel source both (a) directly and (b) by driving the convection current that draws fresh air over the burning fuel. In the present invention, this convection current is prevented or severely hindered by not having any air inlets at the level of the fuel in order to limit the rate of vaporisation to a manageable level.

Most importantly, full combustion of vaporised fuel occurs. This takes place within the combustion chamber and therefore below any cooking vessel that is placed on the cooking stove. By ensuring that combustion is substantially complete before the combusting fuel exits the combustion chamber, the risk that the flame would cool below the flash point of the fuel is minimised. This would otherwise generate smoke.

Surprisingly, full combustion occurs at different speed settings of the fan, and different beneficial effects are seen at these different speeds.

A typical FAE solid fuel block comprising methyl decanoate burns freely with a flame temperature of about 600° C. Using a cooking stove according to the invention that has a fast fan configuration, combustion with a flame temperature approaching 1000° C. can be achieved, however, the fuel block is used up more rapidly. By using a slower fan configuration, the flame temperature can be dropped to 800° C., but, surprisingly, the burn duration can be doubled over that of the free burn. This provides an indication of just how much extra energy can be captured from the FAE fuel block by the cooking stove of the invention.

Surprisingly, even at very slow fan speeds, the cooking stove of the present invention still operates efficiently. Even though the overall rate of combustion of the solid fuel block is slowed, full combustion of the fuel can still occur with the result that no smoke is generated and the flame is not extinguished. It is thought that the present invention allows this effect to occur due to the decreased vaporisation of FAE fuel from the fuel block. This decreased vaporisation is likely to be occurring due to a decreased feedback of heat from the headspace combustion and/or from an increase in the vapour pressure of the vaporised FAE fuel around the fuel block.

Similarly advantageous effects can be seen using solid hexamine fuel blocks.

Other fuel systems, such as liquid hydrocarbon fuels in a container comprising a wick, can also benefit from cooking stoves according to the invention. Such liquid hydrocarbon fuels include kerosene, gasoline, alcohols and diesel, as well as FAE. The present invention allows high energy liquid fuels that usually burn with a sooty flame (that is, undergo incomplete combustion) to be fully combusted. Full combustion occurs when there is enough oxygen to burn all of the vaporised fuel. High energy fuels require a lot of oxygen to fully combust. The invention operates by forcing air (i.e. increasing oxygen delivery) to the headspace above the fuel so that the vaporised fuel can more fully combust. At the same time, by preventing the air blowing directly onto the fuel, vaporisation of new fuel into the headspace does not occur at a rate that outcompetes the amount of oxygen required for full combustion. The invention therefore increases the potential of the fuel by assisting with full combustion, and increases efficiency of the stove by helping to ensure that the full combustion occurs beneath a cooking vessel.

By ‘container comprising a wick’, we generally mean a metal container that is closed apart from an aperture that is fully occupied by the wick. The advantage of using such a container comprising a wick is that the fuel is hindered from spilling if the stove is accidentally knocked over, helping to mitigate a possible safety risk. The wick may comprise glass rope, otherwise known as stove rope or fire rope. This is particularly advantageous as the fuel can be burnt without burning the wick. The rope may be folded back over itself one or more times in order to fully occupy the aperture in the container. This also has the effect of increasing vaporisation of the fuel through providing a larger surface area for fuel to vaporise from.

The dimensions of the container would be such that the fuel vaporisation occurs below the air inlets of the combustion chamber. The wick should therefore sit below the air inlets of the combustion chamber. For example, if the combustion chamber has air inlets 70 mm above the base of the combustion chamber, the height of the container plus wick should be less than about 50 mm.

An additional way to control combustion is to control the rate at which exhaust fumes can leave the combustion chamber. While a combustion chamber is typically open at the top, when heating a cooking vessel the cooking vessel will largely block off the open top. If the cooking vessel sits flush with the top of the combustion chamber, the walls of the combustion chamber should have exhaust outlets. Alternatively, the cooking vessel may be supported above the combustion chamber by a cooking vessel support frame. The height of the cooking vessel support frame controls the area through which exhaust gasses can escape the combustion chamber. The cooking vessel support frame may be configured to hold a cooking vessel between 10 mm and 20 mm, preferably 12 mm and 18 mm, more preferably 15 mm, above the top of the combustion chamber.

Therefore, a number of different stoves according to the invention can be made, each customised to meet different requirements, such as compatibility with different fuel types. In an optional embodiment the cooking stove may have a means for turning the speed of the fan up and down. This allows control over the rate of combustion and amount of heat delivered to the cooking vessel. The stove of the present invention can, for example, be set to a rapid fan speed and therefore a rapid burn to bring the contents of a cooking vessel to the boil, and then turned down to simmer for the remainder of the cooking. This is an advantage typically only seen with cooking systems that can control the rate of delivery of the fuel, such as a gas hob.

In one embodiment, the combustion chamber comprises an insert, the insert providing the base of the combustion chamber and at least the first 40 mm of the walls extending from the base of the combustion chamber. This means that the original combustion chamber of a conventional cooking stove may be converted by using an insert to create a cooking stove according to the invention. The insert modifies the original combustion chamber, and ensures that any fuel placed into the modified combustion chamber is combusted in accordance with the invention. Different types of insert are conceivable. The insert is at least 40 mm tall and air inlets provide air at least 30 mm above the base of the modified combustion chamber. The insert may provide the walls of the combustion chamber, by which we mean the entire height of the walls of the combustion chamber. Such an insert therefore comprises air inlet holes at least 30 mm from the base.

The insert may be reversibly attachable to a conventional cooking stove i.e. a cooking stove having air inlets at the height of fuel. This provides a significant advantage; a single stove can be rapidly changed between a stove configured to burn lower energy density fuel such as biomass (wood, wood pellets, peat, coal, etc) i.e. a conventional cooking stove and a stove according to the invention configured to burn higher energy fuel such as refined hydrocarbons (fuel blocks, liquid fuels in a wicked container, including kerosene, gasoline, alcohols, and diesel, as well as FAE). By providing such a stove with a reversibly attachable insert and/or an appropriately sized wicked container, the user is equipped to burn a wide variety of fuels. This is particularly important in a survival or military situation.

The cooking stove may also comprise a fuel delivery chute attached to the stove such that fuel placed on the delivery chute transitions to the combustion chamber. The fuel delivery chute may be reversibly attached. The fuel delivery chute allows fuel to be introduced to the combustion chamber without the user needing to place their hand over the combustion chamber. This is useful when fuel is already being combusted within the stove and the fuel needs to be replenished. There are two main benefits. First, the user is at a reduced risk of a burnt hand. Second, the cooking vessel does not need to be removed in order for the fuel to be added.

### BRIEF DESCRIPTION OF THE DRAWINGS

The invention will now be described by way of example only with reference to the accompanying figures, in which:

FIG. 1 is a schematic view of a vertical cross-section of a cooking stove according to a preferred embodiment of the invention;

FIG. 2 is a schematic view of a vertical cross-section of the cooking stove of FIG. 1 further comprising a thermoelectric generator;

FIG. 3 is a graph showing the temperature against time of a flame generated by burning a FAE solid fuel block in a cooking stove according to the invention under different forced air conditions and also of flames generated in control experiments;

FIG. 4 is a graph showing the temperature against time of 5 litres of water in a cooking vessel on a stove according to the invention with a burning FAE solid fuel block under different forced air conditions and also of a control experiment;

FIG. 5 is a schematic view of a vertical cross-section of an insert for use in an embodiment of the invention;

FIG. 6 is a schematic view of a vertical cross-section of a cooking stove with insert according to an embodiment of the invention;

FIG. 7 is a schematic perspective view of an insert for use in an embodiment of the invention;

FIG. 8 is a schematic lower perspective view of an insert for use in an embodiment of the invention;

FIG. 9 is a schematic perspective view of a cooking vessel support framework for use in an embodiment of the invention;

FIG. 10 is a schematic perspective view of a fuel delivery chute for use in an embodiment of the invention; and

FIG. 11 is a schematic view of a vertical cross-section of a container comprising a wick for use in an embodiment of the invention.

### DESCRIPTION

According to a first aspect, the present invention provides a cooking stove comprising: a combustion chamber which is defined by walls and a base, the walls having one or more air inlets; and a fan configured to force air into the combustion chamber through the one or more air inlets; characterised in that the one or more air inlets in the walls of the combustion chamber are positioned at least 30 mm from the base. The one or more air inlets in the walls of the combustion chamber may also be positioned at least 35 mm, preferably 40 mm, from the base. With larger cooking stoves, the one or more air inlets may be positioned at least 70 mm or at least 110 mm from the base.

By combustion chamber, we mean the section of the cooking stove where combustion of fuels takes place. The combustion chamber is defined by walls and a base and extends in height between the base of the combustion chamber and the top of the walls which usually form a surface of the cooking stove that a cooking vessel is placed on. Alternatively, a support may extend above the cooking stove and the cooking vessel is instead placed on the support. The walls may consist of a number of panels that define a prism shape, such as a hexagonal prism, or may consist of a singular continuous panel that defines a cylinder, oval or other smoothly contoured shape, or a combination of these. The walls may be vertical or may be angled so that the cross-sectional area of the combustion chamber varies with height. The base of the combustion chamber is the surface that fuel such as a solid fuel block is placed on. The base of the combustion chamber is not necessarily the base of the cooking stove.

The air may be delivered from the fan to the one or more air inlets by any suitable means. By this, we mean that when the fan is operational, i.e. rotating, air is driven from one side of the fan to the other. This generates a positive pressure of air on one side of the fan. The fan is configured so that a pressure differential exists where the air on the outside of the air inlets is a higher pressure than the air inside the combustion chamber, and air is therefore forced into the combustion chamber. Air delivery may be through conduits leading from the fan to each of the air inlets. Alternatively, air delivery may be through the stove having another wall encompassing the combustion chamber which creates an enclosed section where the fan creates a higher air pressure, the air being driven through the one or more air inlets to the combustion chamber.

The air inlets are effectively simple holes in the walls of the combustion chamber that air can flow into when the stove is in use.

Exhaust outlets may be provided in the walls of the combustion chamber, and may be arranged above the air inlets. Exhaust outlets would be used in embodiments of the cooking stove where the cooking vessel would sit on the top of the combustion chamber walls. Exhaust outlets allow the exhaust gasses to leave the combustion chamber. The exhaust gasses comprise fully combusted products, typically carbon dioxide and water, oxygen depleted air and potentially fuel that is still combusting. Allowing exhaust gasses out of the combustion chamber allows turnover of air and sustains combustion.

The exhaust fumes are hot, and exhaust outlets may be arranged in such a way as to protect a handle of a cooking vessel from this heat. There may be 5 exhaust outlets, each having dimensions of about 4 mm tall by about 20 mm wide. The exhaust outlets may be in the form of perforations in the walls of the combustion chamber, and may be 2 mm to 3 mm below the upper surface of the cooking stove. Alternatively, the exhaust outlets may be in the form of castellations at the top of the wall so that the exhaust outlets become bordered on all sides, and thus fully formed, when the cooking vessel is placed on top of the stove.

In an alternative embodiment, a cooking vessel support frame may extend above the cooking stove and the cooking vessel is placed on the support. The support may, for example, be a metal framework that holds the cooking vessel at a distance above the combustion chamber. The cooking vessel support frame may comprise a number of tines, such as 3, 4 or 6 tines. These tines may be attached to the cooking stove or cooking stove insert, or may be a separate component that is placed on the cooking stove or cooking stove insert before use. The tines generally extend vertically from the cooking stove to provide separation of the cooking vessel from the cooking stove. The tines may also be curved, so that a section of the tine provides a flat surface to place the cooking vessel on. The cooking vessel support frame may be configured to hold a cooking vessel between 10 mm and 20 mm, preferably 12 mm to 18 mm, more preferably 15 mm, above the top of the combustion chamber. When a cooking vessel support frame is used exhaust gasses can leave the combustion chamber through the gap between the top of the combustion chamber walls and the cooking vessel. In this embodiment, there do not need to be exhaust outlets in the walls of the combustion chamber.

In the first aspect of the invention, the one or more air inlets are positioned at least 30 mm from the base of the combustion chamber. The combustion chamber is substantially free from air inlets below 30 mm from the base of the combustion chamber. By this, we mean that the lowermost opening of each of the one or more air inlets should be this distance from the base of the combustion chamber. A standard FAE solid fuel block height is 20 mm. Hexamine blocks can be the same size, or even smaller, for example 45×45×12 mm. Therefore, the air inlets are generally at least 10 mm from the top surface of such a fuel block. Alternatively, the air inlets can be at least 35 mm or at least 40 mm from the base of the combustion chamber. Larger fuel blocks could be used to cook for more than one or two people, for example in a humanitarian situation. For a cooking stove configured to a fuel block that is 40 mm tall, the one or more air inlets should be at least 50 mm from the base of the combustion chamber. According to the second and third aspects of the invention, the air inlets are defined in relation to a solid fuel block as being above a solid fuel block which is placed on the base of the combustion chamber. The same principles apply for liquid fuels in a container comprising a wick.

The one or more air inlets may be in the top half of the combustion chamber.

The one or more air inlets may have a combined surface area of 20 mm² to 500 mm², preferably 50 mm² to 400 mm², more preferably 80 mm² to 350 mm². These dimensions help to ensure an optimal airflow to the headspace above a burning solid fuel block.

The stove of the present invention can have 4 to 20, preferably 6 to 18, more preferably 8 to 16 air inlets. Where there is more than one air inlet, the air inlets may be spaced evenly around a perimeter of the combustion chamber. Spacing the inlets evenly around such a perimeter helps to ensure that all fuel is combusted and that a steady and even burn is achieved. This also helps to control and limit convection currents within the combustion chamber that could otherwise drive air over the solid fuel block and increase the rate of vaporisation of the fuel. Spacing the air inlets evenly around the perimeter of the combustion chamber helps to ensure that air can be delivered evenly to all sides of the combusting vaporised fuel while also maintaining structural integrity of the cooking stove.

The cooking stove may further comprise a heat shield configured to protect the fan. A significant amount of heat is generated in the combustion chamber, which will be transmitted to the surroundings. Such heat could cause a fan to malfunction by, for example, melting or charring components of the fan. A heat shield can be provided to protect the fan from the heat of the combustion chamber, particularly infra-red radiative heat. The heat shield should therefore block the line of sight between any part of the combustion chamber and any part of the fan. The heat shield may be made of any non-flammable material that can absorb radiative heat and dissipate that heat to the surroundings, particularly by conduction, such as stainless steel, mild steel, titanium, copper or heat-stable polymeric compounds such as carbon fibre matrix. A particularly preferred material is aluminium, due to cost, resistance to oxidation and excellent heat-sink properties.

The fan, heat shield and combustion chamber are preferably in a vertical assembly, with the fan at the bottom, combustion chamber at the top, and the heat shield between the fan and combustion chamber. This specific arrangement of fan and heat shield in relation to the combustion chamber is particularly advantageous. Hot air rises, so it is beneficial to have the fan below the combustion chamber to protect it from this convective heat. Heat is also radiated from the combustion chamber, which is why it is preferred to position a heat shield between the combustion chamber and the fan. It is also beneficial to have the fan blowing on the heat shield as this recycles heat that is conducted and radiated from the heat shield to the air being blown through the cooking stove.

The fan may be electrically driven, such as by a battery, rechargeable battery, capacitor storage device, socket adapted to receive AC or DC electricity, thermoelectric generator, wind-up generator, solar power generator or combination thereof. By this, we mean that the fan comprises an electric motor which transduces electrical energy into rotation of the fan. The electrical energy may be provided by any of the means listed. Furthermore, the rechargeable battery may be recharged by any other source of electricity, including being connected to external AC or DC electricity, a thermoelectric generator, a wind-up generator, a solar power generator, or a combination of these. By having the fan powered by a renewable source such as a thermoelectric generator, wind-up generator or solar panel, which can also store electricity in a rechargeable battery, the stove becomes self-contained. That is, such a cooking stove is not dependent on consumable components such as non-rechargeable batteries and does not need to be close to a mains power outlet.

Alternatively, the fan may be mechanically driven and this may be by a wind-up spring, kinetic storage device such as a rotating fly-wheel or a means for attaching an external drive shaft or belt drive. By this, we mean that the fan may be driven by mechanically transducing the potential energy of a wound up spring or suspended weight into rotation of the fan. The transduction of energy to the fan may be controlled by means well known in clock making. The energy may be transferred from a source external to the cooking stove, such as a water wheel or suspended weight. Means for powering the fan that do not require electricity are particularly useful in regions where electricity is not readily available, such as in remote regions or disaster relief areas. Equally, mechanical energy could be converted to electrical energy to drive an electric fan or recharge a rechargeable battery.

The cooking stove may further comprise means for manipulating the speed of the fan. By this, we mean that the cooking stove will have a dial or other control that the user can use to modify the speed of the fan. For an electric fan, this may be through a variable resistor. For a mechanical fan, this may be a means of applying mechanical braking or a constantly variable drive such as a variomatic drive. With such means, the user can adjust the speed of the fan to suit cooking needs conveniently. As discussed above, the forced air can be delivered at different rates to control the rate of combustion. This can be done during the cooking process, if required.

The fan may be driven directly or indirectly by a thermoelectric generator, wherein the thermoelectric generator has a hot side and a cold side, and wherein the hot side is directly or indirectly in thermal contact with the combustion chamber. This exploits the temperature differentials within the stove to generate electricity, making this embodiment of the cooking stove completely self-sustaining when in use. The hot side may be in direct or indirect thermal contact with the heat shield. Furthermore, the cold side of the thermoelectric generator may be cooled by the fan. This further increases the temperature differential across the thermoelectric generator, allowing for an increased generation of electricity. The external device powered by the stove could, for example, be a light or a charging station for a mobile phone, or computer, or camera etc.

The thermoelectric generator may have an additional power outlet suitable for powering a device external to the cooking stove. This allows a self-sustaining cycle of using the generated heat to power the fan, which in turn increases combustion efficiency.

The combustion chamber may be reversibly detachable from the fan. By this, we mean that the portion of the cooking stove comprising the surfaces exposed to the burning fuel (i.e. the base and walls of the combustion chamber) can be detached from the remainder of the cooking stove. This is so that these surfaces can be washed without admitting water or cleaning agents to other parts of the cooking stove, in particular, the fan or any components for driving the fan. This also allows the combustion chamber to be replaced with different combustion chambers, for example, combustion chambers tuned to efficiently burn different fuel types. There are a number of features that can be optimised in different combustion chambers, such as air inlet number, size, arrangement and height from the base.

Any power source of the cooking stove may also be reversibly attachable. This allows consumable components, such as batteries, to be replaced. It also allows the power source to be modular and, for example, a thermoelectric generator may be replaced by a solar power generator.

The cooking stove may further comprise one or two handles, which allows the stove to be easily moved, even when it is hot from use. The cooking stove may also comprise a section of the perimeter that is free from exhaust outlets such that the stove handle or cooking vessel handle is protected from the heat of combustion.

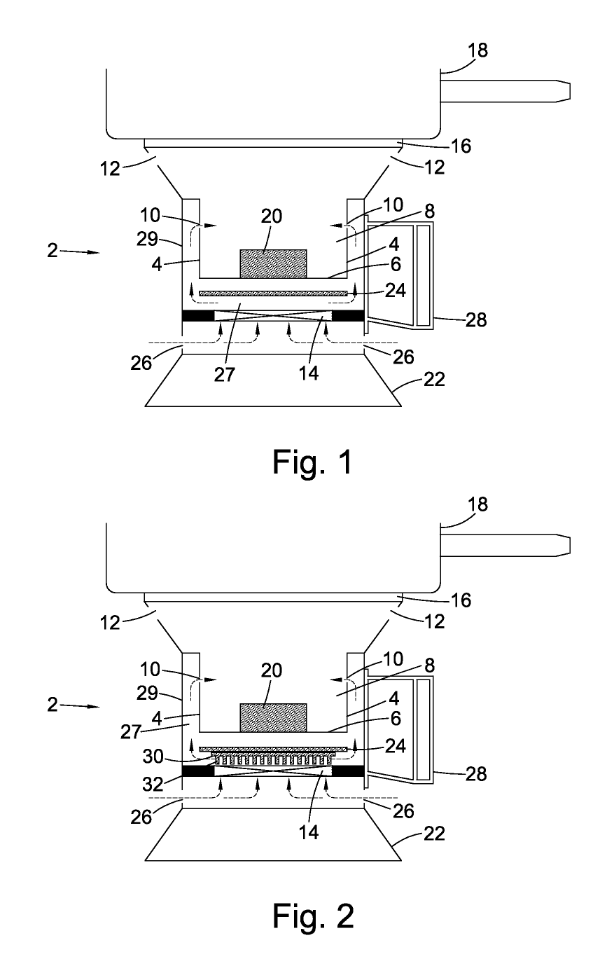

The cooking stove may also be substantially as described herein with reference to the accompanying FIGS. 1, 2 and 6.

According to one embodiment of the invention, the combustion chamber comprises an insert, the insert providing the base of the combustion chamber and at least the first 40 mm of the walls extending from the base of the combustion chamber. By insert, we are referring to a device that can be inserted into a cooking stove, for example in to the original combustion chamber of a cooking stove, to form part of, or all of, the combustion chamber in accordance with the present invention.

Different types of insert are conceivable, but all are capable of modifying a conventional cooking stove so that it becomes a cooking stove according to the invention.

The insert may provide walls that are only 40 mm in height. The fuel is placed into the insert, and the insert prevents the cooking stove from supplying air to the fuel within 30 mm from the base. The insert therefore becomes the lower part of the modified combustion chamber. The insert blocks any air inlets in the base of the original combustion chamber or within 30 mm of the base in the walls of the original combustion chamber. The insert may lie flush against such air inlets, but this is not necessary because the airflow is still prevented from blowing directly on the fuel sitting within the modified combustion chamber.

The insert may provide the walls of the combustion chamber. By this, we mean that the insert provides the entire height of the walls of the combustion chamber according to the present invention. The combustion chamber according to the present invention sits within the original combustion chamber. In this situation, the walls of the insert will have air inlet holes. According to the invention, the air inlet holes are at least 30 mm from the base of the insert. The insert may have exhaust outlets. The insert should substantially seal the original combustion chamber so that the air delivered to the original combustion chamber is directed through the modified combustion chamber's air inlets into the modified combustion chamber which is provided by the insert. This type of insert may be configured so that the air inlets sit above the original combustion chamber, within a collar that equalises air pressure around the air inlets. This is particularly useful if the insert is a tight fit within the original combustion chamber and certain regions of the insert and original combustion chamber lie flush against one another.

Alternatively, the insert may replace the original combustion chamber. In this embodiment, the original combustion chamber is completely removed from the cooking stove, and the insert placed into the cooking stove.

The insert may be reversibly attachable, which would allow easy interconversion between a stove configuration according to the invention, with the insert, for burning high energy fuel and a stove configuration without the insert for burning biomass such as wood, coal, peat, etc.

According to a second aspect, the present invention provides a method of heating a cooking vessel using a cooking stove, the cooking stove comprising: a combustion chamber which is defined by walls and a base, the walls having one or more air inlets; and a fan configured to force air into the combustion chamber through the one or more air inlets; the method comprising the steps of: placing (a) a solid fuel block comprising methyl, ethyl, propyl or butyl esters of a C6 to C14 carboxylic acid or combinations thereof, or hexamine, or (b) a container comprising a wick and a liquid fuel on the base of the combustion chamber and setting the solid fuel block or container comprising a wick and a liquid fuel alight; using the fan to force air through the one or more air inlets in the walls of the combustion chamber, wherein the one or more air inlets are all positioned above the solid fuel block or container comprising a wick and a liquid fuel; and placing a cooking vessel onto the cooking stove.

The method may further comprise adjusting the speed of the fan. The one or more air inlets in the walls of the combustion chamber may be at least 10 mm, preferably 15 mm, more preferably 20 mm, above the solid fuel block. The method may also comprise using a cooking stove with any of the features of the first aspect of the invention.

According to a third aspect, the present invention provides a kit comprising a cooking stove and one or more solid fuel blocks and/or a container comprising a wick, wherein the one or more solid fuel blocks comprise methyl, ethyl, propyl or butyl esters of a C6 to C14 carboxylic acid or combinations thereof, or hexamine, and wherein the cooking stove comprises: a combustion chamber which is defined by walls and a base, the walls having one or more air inlets; and a fan configured to force air into the combustion chamber through the one or more air inlets; and characterised in that the one or more air inlets in the walls of the combustion chamber are configured to deliver air into the combustion chamber above the solid fuel block or container comprising a wick when the solid fuel block or container comprising a wick is positioned on the base of the combustion chamber.

The stove in the kit may have one or more air inlets in the walls of the combustion chamber configured to deliver air into the combustion chamber more than 10 mm, preferably 15 mm, more preferably 20 mm, above the solid fuel block. The kit may also comprise a cooking stove with any of the features of the first aspect of the invention.

FAE solid fuel blocks typically comprise a methyl, ethyl, propyl or butyl ester of a C6 to C14 carboxylic acid or combination thereof encapsulated in a solid emulsion. Solid fuel blocks comprising methyl decanoate are preferred in the present invention. A solid fuel block comprising an emulsion of methyl decanoate encapsulated in a resin is available on the market under the name “Zip Military Cooking Fuel”®. These fuel blocks comprise about 20% by weight resin/water/emulsifier matrix and about 80% by weight methyl decanoate. Two sizes are available, a 26 g block that is 42 mm long, 32 mm wide and 20 mm tall, and a 100 g block that is 60 mm long, 60 mm wide and 40 mm tall.

As noted above, hexamine solid fuel blocks are on the market and are well known to a person working in this field. They are often used by the military. Hexamine is the common name for hexamethylenetetramine or methenamine, which is a heterocyclic organic compound with the formula (CH₂)₆N₄. This is the main component of hexamine fuel tablets. Tablets currently on the market have block size 45×45×12 mm. Hence, two or more blocks can be stacked on top of one another if required. Traditionally hexamine blocks are not suitable for indoor use, due to the fact they undergo incomplete combustion in prior art stoves. A well known disadvantage is also the unpleasant smell of the partial combustion products. As noted above, by using the stove according to the present invention, these problems can be mitigated.

Alternatively, other fuels that are similar to FAE fuel blocks may be used. As already mentioned, a FAE fuel block is a high-energy liquid fuel encapsulated in a solid emulsion. Other high-energy hydrocarbons, such as kerosene, gasoline, diesel, and alcohols, may be used.

Furthermore, the liquid fuel may be housed within a container comprising a wick, i.e. a wicked container, instead of being encapsulated in a solid emulsion. The container comprising a wick can be inserted into the combustion chamber instead of a solid fuel block. The airflow should still be directed above the site of fuel vaporisation, i.e. the wick. The airflow helps to ensure full combustion of the vaporised fuel occurs, minimising the amount of soot generated by the cooking stove.

A container comprising a wick may be cylindrical with a diameter of about 95 mm and a height of about 50 mm, providing a volume of about 350 ml. This should be used in combination with a cooking stove where the air inlets are at least 70 mm above the base of the combustion chamber. A taller container comprising a wick may be used. For example, an 80 mm tall container would have a volume of about 550 ml. Such a container should be used with a combustion chamber having air inlet holes at least 110 mm above the base of the combustion chamber.

The cooking stove may also comprise a fuel delivery chute, the fuel delivery chute attached to the stove such that fuel placed on the delivery chute transitions to the combustion chamber. The chute may be a simple sheet that the fuel can slide down under gravity. The sheet can have side walls to guide the fuel. The fuel delivery chute may also be reversibly attachable, for example, by clipping into the cooking stove such that one end of the delivery chute is held at the top of the combustion chamber. The delivery chute may also have perforations or slots to allow ambient air through. This helps to keep the delivery chute cool to further reduce the risk of burnt hands.

### DETAILED DESCRIPTION OF DRAWINGS

FIG. 1 is a schematic view of a vertical cross-section of a cooking stove according to the invention, and shows a cooking stove 2 comprising walls 4 and a base 6 which define a combustion chamber 8, the walls 4 comprising air inlets 10 and exhaust outlets 12; a fan 14 configured to force air into the combustion chamber 8 through the air inlets 10. The air inlets 10 are located in the walls 4 of the combustion chamber 8 at least 30 mm from the base 6. This is above the fuel block 20.

As can be seen in FIG. 1, the walls 4 of the combustion chamber 8 may comprise a number of different sections. In this embodiment, the walls 4 continue up to the exhaust outlets 12 and then to a rim 16 that a cooking vessel 18 is placed on. The combustion chamber 8 therefore extends in height between the base 6 and the rim 16.

The base 6 of the combustion chamber 8 has a fuel block 20 placed on it. The cooking stove 2 shown in FIG. 1 also has a bottom section 22.

The cooking stove 2 comprises a fan 14 configured to force air into the combustion chamber 8. In the cooking stove 2 shown in FIG. 1, this is achieved by having the fan 14 forcing air into an enclosed space 27 existing between the fan 14, the base 6 of the combustion chamber 8, the walls of the combustion chamber 10 and a secondary wall 29 that encloses a portion of the combustion chamber 8 that contains the air inlets 10.

The cooking stove 2 further comprises a heat shield 24 configured to protect the fan 14 from the heat generated in the combustion chamber 8. The fan 14, heat shield 24 and combustion chamber 8 are in a vertical assembly, with the fan 14 at the bottom, combustion chamber 8 at the top, and the heat shield 24 between the fan 14 and combustion chamber 8. This allows the heat captured from the combustion chamber 8 by the heat shield 24 to be dissipated by conduction and radiation to the air that is being forced over the heat shield 24 by the fan 14.

The cooking stove 2 may also comprise a handle 28. The handle should remain cool during operation of the cooking stove and allows the cooking stove to be conveniently moved during or after use.

The cooking stove 2 of FIG. 1 operates by placing a solid fuel block 20 on the base 6 of the combustion chamber 8. The fuel block 20 may comprise a methyl, ethyl, propyl or butyl ester of a C6 to C14 carboxylic acid or combination thereof. The fuel block 20 is then set alight, and left for around 20 to 30 seconds to ensure that the entire surface of the fuel block catches fire. The fan 14 is then started and a cooking vessel 18 placed onto the cooking stove 2. In operation, the fan 14 draws air in through one or more stove inlets 26 and forces it into the enclosed space 27. The air passes the heat shield 24 and carries away heat transferred to the air from the heat shield 24. The air then enters the combustion chamber 8 through the air inlets 10. The air enters the combustion chamber 8 at a position above the top surface of the fuel block 20. This airflow route is shown in FIG. 1 by dashed arrows. The air then exits the combustion chamber through the exhaust outlets 12.

FIG. 2 shows a schematic of the cooking stove 2 of FIG. 1 further comprising a thermoelectric generator 30 having a hot side and a cold side. The hot side of the thermoelectric generator 30 is positioned to be in contact with the heat shield 24.

The cold side of the thermoelectric generator 30 is positioned to face the fan 14, and is therefore cooled by the fan 14. The cold side of the thermoelectric generator 30 is shown having a heat sink 32 to further dissipate heat to the forced air driven up by the fan 14.

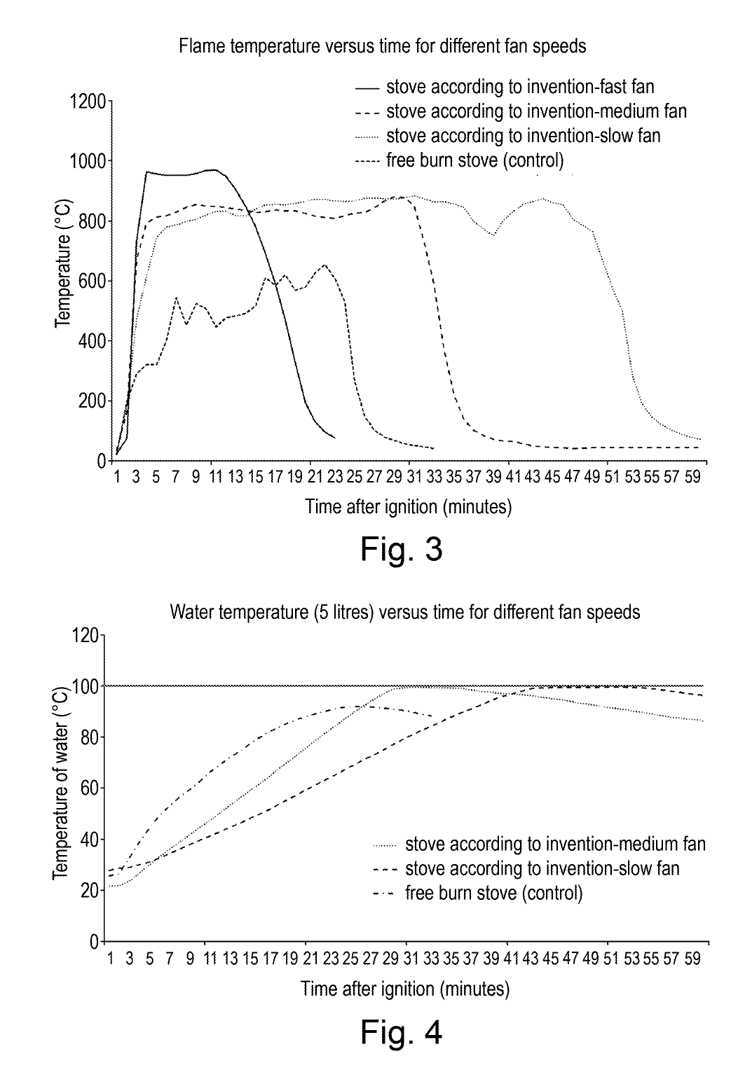

FIG. 3 shows a graph of flame temperature against time after ignition for a 100 g methyl decanoate fuel block in a cooking stove according to the present invention as shown in FIG. 1 and also for a control experiment. The methyl decanoate fuel block comprised methyl decanoate encapsulated in a resin, with dimensions of 60 mm by 60 mm by 40 mm. The cooking stove had air inlets 50 mm above the base. A cooking vessel was placed on top to simulate real usage conditions. The control burn was of the same methyl decanoate fuel block with unrestricted air access and exhaust. The fuel block burned with a temperature of around 600° C. for a duration of around 25 minutes. By comparison, burning the fuel block in the cooking stove according to the invention with a medium fan (75 mm diameter; approximately 3000 rpm) and a slow fan (75 mm diameter; approximately 1500 rpm) achieved a temperature of around 800 to 900° C. and lasted for 34 and 50 minutes respectively. Thus, the cooking stove extends the duration of the burn time as well as increases the temperature of the burn. It can be seen from these experiments alone that the cooking stove significantly enhances the usefulness of a single fuel block. The increased oxygen delivery, through forcing air into the flame, ensures maximised combustion of all fatty acid ester and urea-formaldehyde resin matrix. The amount of soot produced was therefore dramatically reduced.

Yet furthermore, when the fan was set to a high speed fan (75 mm diameter; 5000 rpm) the burn time was reduced to around 13 minutes but the flame temperature rose to around 900 to 1000° C. This demonstrates that with a single fuel block, a cooking vessel could be rapidly heated at high temperature, before turning down the fan speed to allow the contents to simmer and also preserve the duration of the burn of the remainder of the fuel block.

FIG. 4 shows an analogous experiment to that described for FIG. 3, but measuring the time to boil and boil duration of 5 litres of water in a cooking vessel placed on the cooking stove. The initial temperature of the water in all experiments was 20° C. First, the free burn on a cooking stove where airflow was not controlled resulted in the water not achieving a boil. By using the stove of the present invention, medium fan and slow fan settings achieved boil. The times to boil were about 30 minutes and 43 minutes, and the boil durations about 5 minutes and 10 minutes. It should be realised that the cooking stove of the present invention is not limited to the examples given above. For example, the invention covers embodiments of the stove where the air admitted to the combustion chamber is further controlled. The air may be directed in a particular direction such as in the same direction as the rising flame to provide a wall of air around the flame, or at an offset angle to create a vortex of air within the combustion chamber.

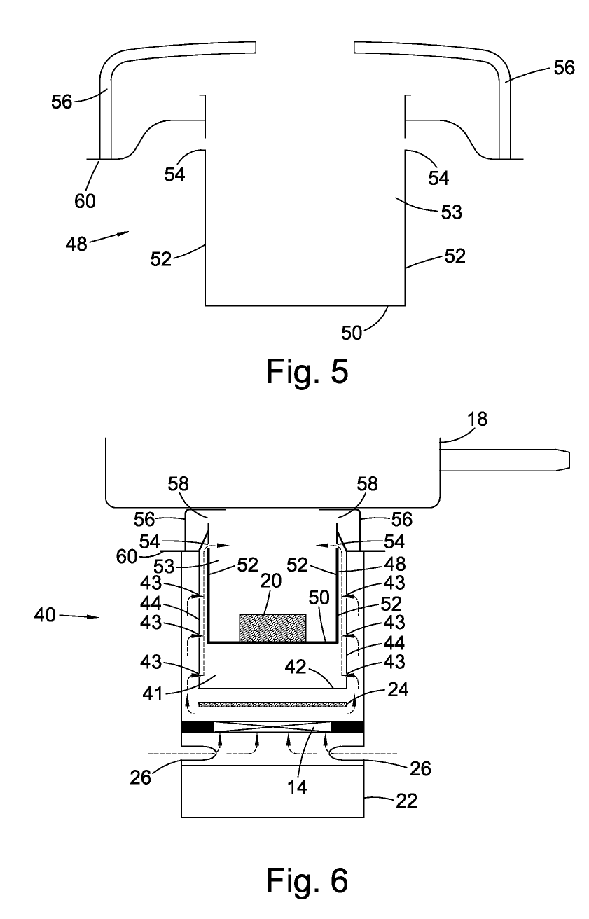

FIG. 5 shows a cross-section schematic of an insert 48 that can be used to turn a conventional portable cooking stove into a cooking stove according to the invention. The insert 48 has a base 50 and walls 52, which define a combustion chamber 53. The walls have air inlets 54, which are positioned at least 30 mm from the base 50. The air inlets 54 can also be described as being in the top half of the combustion chamber 53. A support disc 60 is attached to the wall 52, at a position above the air inlets 54. The support disc 60 extends radially from the wall 52. The inner portion of the support disc 60 is above the air inlets 54. A middle portion of the support disc 60, further away from the wall 52 than the inner portion, curves downwards. An outer portion of the support disc 60 is yet further away from the wall 52 and is below the air inlets 54. The outer portion of the support disc 60 is intended to rest on a cooking stove. In this embodiment, the outer portion of the support disc 60 also supports a cooking vessel support frame in the form of multiple tines 56. These tines 56 will support a cooking vessel above the combustion chamber 53.

FIG. 6 shows a cross-section schematic of a conventional cooking stove 40 that has been modified to a cooking stove according to an embodiment of the invention using an insert 48. The conventional cooking stove 40 has on original combustion chamber 41 defined by an original base 42 and original walls 44. The original walls 44 have the original air inlets 43, and it can be seen that these air inlets 43 would provide forced air at the level of a fuel block. However, the original combustion chamber 41 has been modified by placing the insert 48 in it. The insert 48 is marked by bold lines. The insert 48 has a support disc 60 that sits on the top of the conventional cooking stove 40 and supports the insert 48 in place. The insert 48 has a base 50 and walls 52 that define the insert combustion chamber 53. The fuel block 20 is placed into the insert combustion chamber 53 rather than the original combustion chamber 41. When the cooking stove fan 14 is operated, air is driven into the original combustion chamber 41, which is subsequently driven into the insert combustion chamber 53. The insert air inlets 54 of the insert combustion chamber 53 are at least 30 mm above the insert base 50. This means that air is delivered to the headspace above the fuel block 20 and the fuel block burns efficiently, in accordance with the invention.

In this embodiment, the insert 48 also has a support framework for a cooking vessel 18. The support framework comprises a number of tines 56. The tines 56 hold the cooking vessel 18 a fixed distance above the top of the insert combustion chamber 53. This distance defines an air outlet space 58 between the combustion chamber 53 and cooking vessel 18 that controls the rate at which exhaust fumes can exit the insert combustion chamber 53.

It can be seen that the support disc 60 does not extend in a perpendicular fashion from the insert wall 52, but instead curves downwards before extending in a perpendicular fashion. The air inlets 54 are above the outer part of the support disk 60. This means that the insert air inlets 54 are also above the original combustion chamber 41. This has the effect of creating a region of space that encircles all of the insert air inlets 54, irrespective of the shape of the original combustion chamber 41. This region of space allows the air pressure that drives the air through the insert air inlets 54 to equalise around all of the insert air inlets 54.

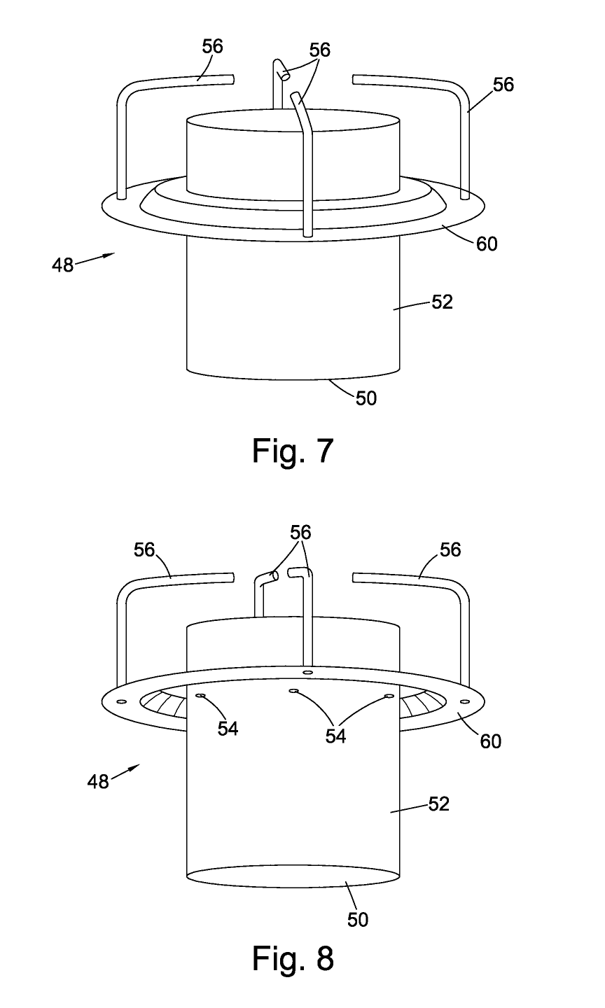

FIG. 7 shows a schematic perspective view of an insert 48 that can be used in an embodiment of the invention. The insert 48 has a base 50 and a wall 52. The insert 48 is cylindrical and is closed at the base 50. The other end of the cylindrical insert 48, opposite the base 50, is open. A support disc 60 extends from the wall 52. The support disc 60 is circular and has an inner section that is relatively raised in relation to a relatively lowered outer section. A middle section transitions between the inner and outer sections. No air inlet or outlet holes are seen above the inner section of the support disc 60. Also shown in this embodiment are four tines 52 that extend from the outer section of the support disc 60. The tines 52 form a cooking vessel support frame.

FIG. 8 shows the insert 48 of FIG. 7, but from a lower perspective. In this view, the air inlets 54 can be seen.

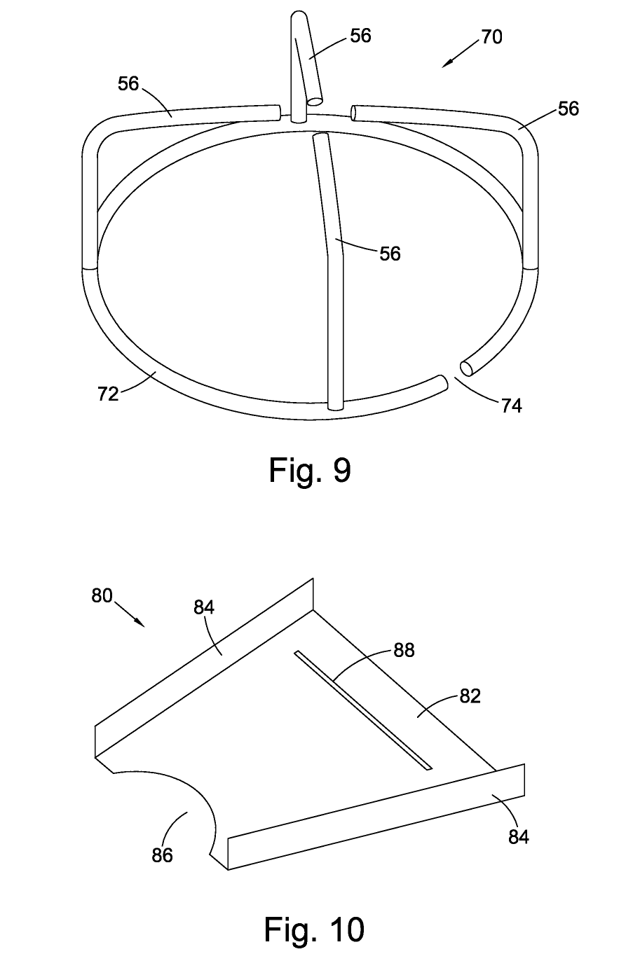

FIG. 9 shows an alternative to having the tines 56 fixed to the support disc 60. In this cooking vessel support framework 70 the tines 56 are affixed to a loop 72. The loop 72 is open, at opening 74, which allows the loop 72 to freely expand and contract with heating and cooling cycles. To use the cooking vessel support framework 70, it is simply placed on a cooking stove, for example, on the support disc 60 of the insert 48.

FIG. 10 shows a schematic perspective view of a fuel delivery chute 80 for use with an embodiment of the invention. The fuel delivery chute 80 comprises a flat sheet 82 with upturned sides 84. The upturned sides 84 help to guide solid fuel along the fuel delivery chute 80. The fuel delivery chute 80 has a curved cut-out 86. This curved cut-out 86 can match the curvature of a combustion chamber. The fuel delivery chute 80 also has a slit 88 that allows ambient air to flow through. This helps to keep the end of the fuel delivery chute 80 relatively cooler.

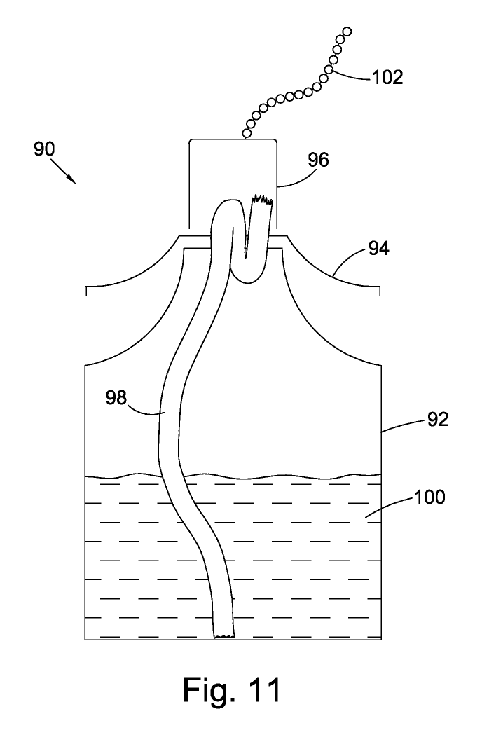

FIG. 11 shows a schematic vertical cross-section of a container comprising a wick 90 that can be used with an embodiment of the invention. The container 92 is shown with a wick 98. The wick 98 is folded in the region of the container opening. This allows the wick 98 to fit tightly into the container opening, creating a better seal, and also creates a higher surface area that fuel 100 can vaporise from. The container 92 is shown with fuel 100 within it. Also shown is a heat shield 94. This protects the container 92 from the heat of the flame and protects against the fuel 100 boiling. A snuffer 96 is also shown. When the wick 98 is lit, the snuffer 96 will not be positioned over the container 92 as shown in FIG. 11. When the flame is to be extinguished, the snuffer 96 will be placed in the position shown, to starve the wick of oxygen. The snuffer 96 is shown with a chain 102 for easy handling.

1. A cooking stove comprising:
a combustion chamber which is defined by walls and a base, the walls having one or more air inlets; and
a fan configured to force air into the combustion chamber through the one or more air inlets;
characterised in that the one or more air inlets in the walls of the combustion chamber are positioned at least 30 mm from the base.

2. A cooking stove according to claim 1, wherein the walls of the combustion chamber have one or more exhaust outlets.

3. A cooking stove according to claim 1, further comprising a cooking vessel support frame, in which the cooking vessel support frame is configured to hold a cooking vessel between 10 mm and 20 mm, preferably 12 mm to 18 mm, more preferably 15 mm, above the top of the combustion chamber.

4. (canceled)

5. A cooking stove according to claim 1, in which the one or more air inlets in the walls of the combustion chamber are positioned at least 35 mm, preferably 40 mm, from the base.

6. A cooking stove according to claim 1, in which the air inlets are in the top half of the combustion chamber.

7. A cooking stove according to claim 1, in which the one or more air inlets have a combined surface area of 20 mm² to 500 mm², preferably 50 mm² to 400 mm², more preferably 80 mm² to 350 mm².

8. A cooking stove according to claim 1, in which the one or more air inlets are spaced evenly around a perimeter of the combustion chamber.

9. A cooking stove according to claim 1, in which there are 4 to 20, preferably 6 to 18, more preferably 8 to 16, air inlets.

10.-13. (canceled)

14. A cooking stove according to claim 1, further comprising means for manipulating the speed of the fan.

15.-17. (canceled)

18. A cooking stove according to claim 1, in which the combustion chamber is reversibly detachable from the fan.

19. (canceled)

20. A cooking stove according to claim 1, in which the combustion chamber comprises an insert, the insert providing the base of the combustion chamber and at least the first 30 mm of the walls extending from the base of the combustion chamber.

21. A cooking stove according to claim 20, in which the insert provides the walls of the combustion chamber.

22. A cooking stove according to claim 20, in which the insert is reversibly attachable to the cooking stove.

23. (canceled)

24. (canceled)

25. A method of heating a cooking vessel using a cooking stove,
the cooking stove comprising:
a combustion chamber which is defined by walls and a base, the walls having one or more air inlets; and
a fan configured to force air into the combustion chamber through the one or more air inlets;
the method comprising the steps of:
placing (a) a solid fuel block comprising methyl, ethyl, propyl or butyl esters of a C6 to C14 carboxylic acid or combinations thereof, or hexamine, or (b) a container comprising a wick and liquid fuel, on the base of the combustion chamber and setting the solid fuel block or container comprising a wick and liquid fuel alight;
using the fan to force air through the one or more air inlets in the walls of the combustion chamber, wherein the one or more air inlets are all positioned above the solid fuel block or container comprising a wick and liquid fuel; and
placing a cooking vessel onto the cooking stove.

26. A method of using a cooking stove according to claim 25, the method further comprising adjusting the speed of the fan.

27. A method of using a cooking stove according to claim 25, wherein the one or more air inlets in the walls of the combustion chamber are all at least 10 mm, preferably 15 mm, more preferably 20 mm, above the solid fuel block or container comprising a wick and liquid fuel.

28. A method of using a cooking stove according to claim 25, wherein the solid fuel block comprises methyl decanoate.

29. A kit comprising a cooking stove and one or more solid fuel blocks and/or a container comprising a wick,
wherein the one or more solid fuel blocks comprise methyl, ethyl, propyl or butyl esters of a C6 to C14 carboxylic acid or combinations thereof, or hexamine, and
wherein the cooking stove comprises:
a combustion chamber which is defined by walls and a base, the walls having one or more air inlets; and
a fan configured to force air into the combustion chamber through the one or more air inlets; and
characterised in that the one or more air inlets in the walls of the combustion chamber are configured to deliver air into the combustion chamber above the solid fuel block or container comprising a wick when the solid fuel block or container comprising a wick is positioned on the base of the combustion chamber.

30. A kit according to claim 29, wherein the one or more air inlets in the walls of the combustion chamber are configured to deliver air into the combustion chamber at a height greater than 10 mm, preferably 15 mm, more preferably 20 mm, higher than a solid fuel block or container comprising a wick when placed on the base of the combustion chamber.

31. (canceled)

32. (canceled)

33. A kit according to claim 29, wherein the solid fuel block comprises methyl decanoate.
